(19) United States
(12) Patent Application Publication
(10) Pub. No.: US 2010/0323732 A1
(43) Pub. Date: Dec. 23, 2010

(54) Radio Communication Method, Radio Communication Base Station Apparatus, Radio Communication Mobile Station Apparatus, And Radio Communication System

(75) Inventors: Yuuta NAKAYA, Kawasaki (JP); Hiroshi FUJITA, Kawasaki (JP); Taiji KONDO, Kawasaki (JP); Tadashi NAKAMURA, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: FUJITSU LIMITED, Kawasaki-shi (JP)

(21) Appl. No.: 12/869,262

(22) Filed: Aug. 26, 2010

Related U.S. Application Data
(63) Continuation of application No. PCT/JP2008/000517, filed on Mar. 10, 2008.

(51) Int. Cl. H04B 7/00

(52) U.S. Cl. 455/501

(57) ABSTRACT

A radio communication method in a radio communication system in which radio communication is performed between a radio communication base station apparatus and a radio communication mobile station apparatus, including: transmitting, by the radio communication mobile station apparatus, an implementation loss value of the radio communication mobile station apparatus to the radio communication base station apparatus.

### CROSS REFERENCE TO RELATED APPLICATIONS

This application is a continuation of International Application No. PCT/2008/000517, filed on Mar. 10, 2008, now pending, herein incorporated by reference.

### FIELD

The embodiments discussed herein are related to a radio communication method, a radio communication base station apparatus, a radio communication mobile station apparatus, and a radio communication system.

### BACKGROUND

Conventionally, an adaptive modulation scheme, which adaptively employ modulation scheme and coding rate according to radio communication state, is used in order to improve transmission efficiency in a downlink of a radio communication system.

FIG. 9A illustrates an example of the prior art of such the adaptive modulation scheme (see for example, IEEE 802.11 a/b/g/n). A mobile station MS uses downlink signal to measure SINR (Signal to Interference plus Noise Ratio), and transmits the result to a base station BS. The base station BS decides a modulation and coding level of the downlink direction based on the SINR. For example, upon judging that downlink communication quality is good based on the SINR, the base station BS uses the modulation and coding level which realizes high transmission efficiency (high modulation order and high coding rate). And, when the communication quality is not good, the base station BS uses the modulation and coding level which realizes low transfer efficiency (low modulation level and low coding rate). The method in FIG. 9A is called a Physical CINR (Carrier to Interface plus Noise Ratio).

Further, FIG. 9B also illustrates an example of the prior art of the adaptive modulation scheme (see for example, IEEE 802.16e-2005). The base station BS requests transmission of MCS (Modulation and Coding Scheme) information to the mobile station MS (Request MCS). The mobile station MS decides the modulation and coding level based on the measured SINR, and transmits the modulation and coding level to the base station BS (Recommended MCS). The base station BS decides a coding and modulation scheme of the down link direction based on the modulation and coding level. The method in FIG. 9B is called an Effective CINR.

In the adaptive modulation by the Physical CINR, the mobile station MS measures the SINR taking various values for a propagation path estimation and similar as ideal values. However, when the mobile station MS actually measures the SINR, various errors (a propagation path estimation error, quantization error, rounding error, and similar during calculation; hereafter also called “implementation loss”) occur. Hence the modulation and coding level selected by the base station BS may not be optimum for the mobile station MS. In such cases, transmission efficiency worsens.

In the adaptive modulation using the Effective CINR (FIG. 5B), the base station BS periodically transmits the request of the MCS information to the mobile station MS. Hence, transmission amount is increased with the transmission of the request, and the problem of overhead also arises. Further, in this scheme, the mobile station MS takes control in deciding the modulation and coding level. However, there are many cases in which it is better that the base station BS take control in making decisions.

On the other hand, it is also conceivable that the base station MS hold the implementation loss value for the mobile station MS, and decide the modulation and coding level using the implementation loss value and the SINR. However, a plurality of mobile stations MS are present, and it is not practical for the base station BS to hold implementation loss values for all of these. Further, it is also conceivable that the base station BS holds the implementation loss value as a fixed value. However, there is individual difference between each of the mobile stations MS, and implementation loss value also differs according to the individual difference. If there is a deviation between the actual implementation loss value and the fixed-value implementation loss value, the optimum modulation and coding level cannot be selected, and transmission efficiency is degraded.

### SUMMARY

According to an aspect of the invention, a radio communication method in a radio communication system in which radio communication is performed between a radio communication base station apparatus and a radio communication mobile station apparatus, including: transmitting, by the radio communication mobile station apparatus, an implementation loss value of the radio communication mobile station apparatus to the radio communication base station apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of the configuration of a radio communication system;

FIG. 2 illustrates an example of the configuration of a modulation and coding level selection judgment unit;

FIG. 3 illustrates an example of a modulation and coding level correspondence table;

FIG. 4 is a sequence diagram illustrating an example of operation of a radio communication system;

FIG. 5 is a sequence diagram illustrating another example of operation of a radio communication system;

FIG. 6 illustrates another example of the configuration of a radio communication system;

FIG. 7 illustrates another example of the configuration of a radio communication system;

FIG. 8 illustrates another example of operation of a radio communication system; and,

FIG. 9A and FIG. 9B illustrate examples of adaptive modulation methods of the prior art.

### DESCRIPTION OF EMBODIMENTS

Preferred embodiments to implement the invention are explained below.

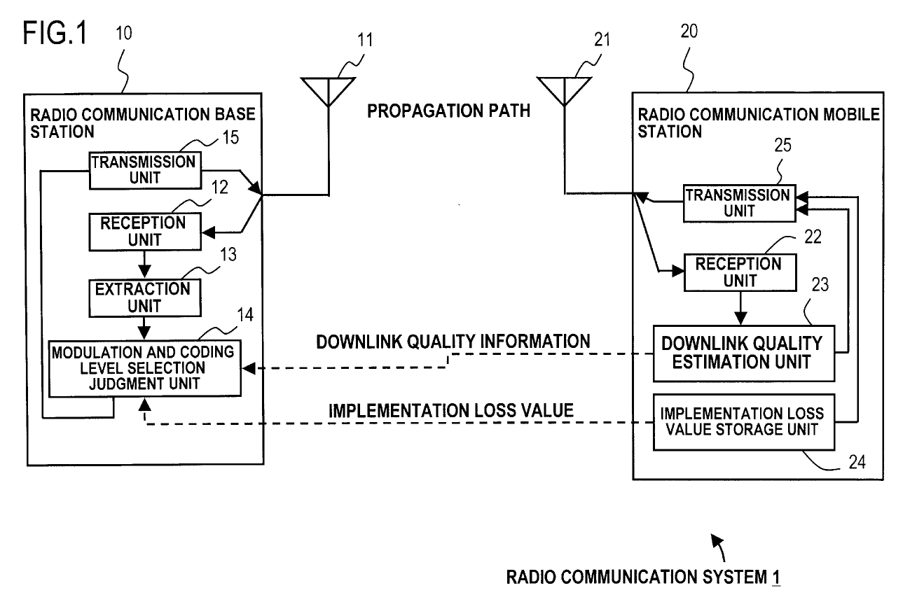

FIG. 1 illustrates an example of the configuration of a radio communication system 1. The radio communication system 1 includes a radio communication base station apparatus (hereafter “base station”) 10, and a radio communication mobile station apparatus (hereafter “mobile station”) 20.

The base station 10 transmits radio signal to the mobile station 20 (downlink direction), and the mobile station 20 transmits radio signal to the base station 10 (uplink direction).

The base station 10 includes an antenna 11, reception unit 12, extraction unit 13, modulation and coding level selection judgment unit 14, and transmission unit 15.

The reception unit 12 inputs radio signal from the mobile station 20 received by the antenna 11, and outputs to the extraction unit 13.

The extraction unit 13 extracts downlink quality information and implementation loss value included in the radio signal, and outputs to the modulation and coding level selection judgment unit 14.

The modulation and coding level selection judgment unit 14 decides a modulation scheme (for example, QPSK, 16QAM, 64QAM, or similar) and coding rate (for example, ½, ⅔, or similar) based on the downlink quality information and implementation loss value, and outputs decision information (a modulation and coding level). The modulation and coding level is represented, for example, by a modulation order corresponding to a modulation scheme and coding rate.

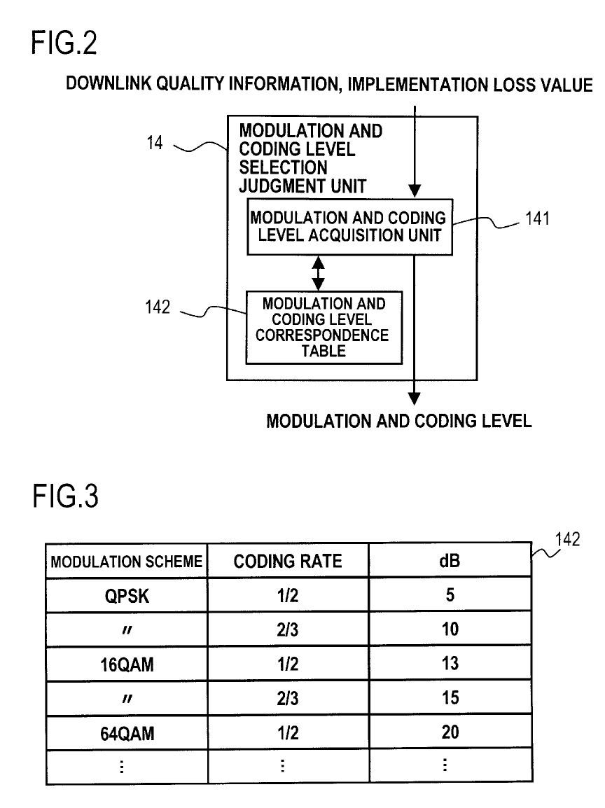

FIG. 2 illustrates an example of the configuration of the modulation and coding level selection judgment unit 14. The modulation and coding level selection judgment unit 14 includes a modulation and coding level acquisition unit 141 and a modulation and coding level correspondence table 142.

The modulation and coding level acquisition unit 141 accesses the modulation and coding level correspondence table 142, and acquires the modulation scheme and coding rate corresponding to the downlink quality information and implementation loss value.

The modulation and coding level correspondence table 142 is a table in which is stored the modulation scheme, the coding rates, and a sum value of the downlink quality information and implementation loss values. FIG. 3 illustrates an example of the modulation and coding level correspondence table 142.

For example, when the SINR is “4 dB” and the implementation loss value is “1 dB”, the modulation and coding level acquisition unit 141 acquires from the correspondence table 142 the modulation scheme “QPSK” and the coding rate “½” corresponding to the sum value of the SINR and implement loss value, which is “5 dB”. Further, when the sum value is “12 dB”, the modulation and coding level acquisition unit 141 acquires the modulation scheme “QPSK” and the coding rate “⅔” corresponding to the value “10 dB” which is equal to or less than the sum value.

Returning to FIG. 1, the transmission unit 15 transmits to the mobile station 20, via the antenna 11, the acquired (decided) modulation and coding level information. Further, the transmission unit 15 transmits to the mobile station 20, via the antenna 11, known signal (pilot signal) used to measure the downlink communication quality.

The mobile station 20 includes an antenna 21, reception unit 22, downlink quality estimation unit 23, implementation loss value storage unit 24, and transmission unit 25.

The reception unit 22 receives, via the antenna 21, radio signal transmitted from the base station 10. Received radio signal includes known signal used to measure the downlink communication quality, and modulation and coding level information. The reception unit 22 outputs the known signal to the downlink quality estimation unit 23.

The downlink quality estimation unit 23 estimates the downlink communication quality based on the known signal, and outputs the estimated communication quality as the downlink quality information to the transmission unit 25. For example, the downlink quality estimation unit 23 measures the SINR from the known signal, and estimates the measured SINR to be the downlink communication quality.

The implementation loss value storage unit 24 stores the implementation loss value. For example, the implementation loss value is found from a simulation or similar, and is stored in the storage unit 24 at the time of factory shipment or similar. The implementation loss value takes on different value for each manufacturer manufacturing mobile stations 20, or for each manufacturing factory, or for each production line within the factory, so that there is individual difference. The implementation loss value is found according to the difference.

The transmission unit 25 transmits to the base station 10, via the antenna 21, the implementation loss value read from the implementation loss value storage unit 24. Further, the transmission unit 25 transmits to the base station 10 the downlink communication quality information from the downlink quality estimation unit 23.

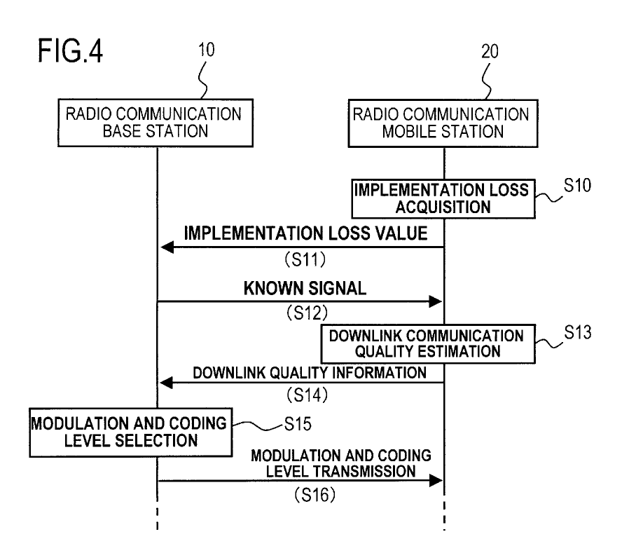

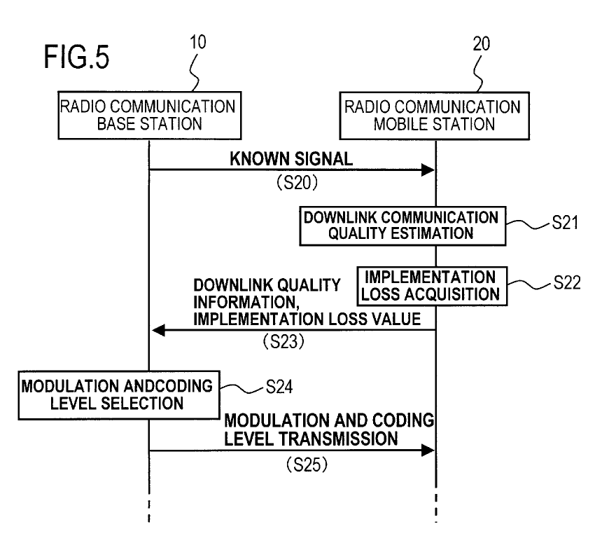

Next, operation in the radio communication system 1 is explained. FIG. 4 is a sequence diagram of an operation example.

First, the transmission unit 25 of the mobile station 20 reads the implementation loss value from the implementation loss value storage unit 24 (S10), and transmits the value at the start of communication (S11).

Next, the mobile station 20 receives the known signal from the base station 10 (S12), and the downlink quality estimation unit 23 of the mobile station 20 estimates the downlink communication quality (S13). For example, the downlink quality estimation unit 23 estimates the downlink communication quality as the measured SINR.

Next, the transmission unit 25 of the mobile station 20 transmits the downlink quality information to the base station 10 (S14).

Next, based on the implementation loss value (S11) and the downlink quality information (S14), the modulation and coding level selection judgment unit 14 of the base station 10 acquires the modulation and coding level from the modulation and coding level correspondence table 142 (S15).

Next, the transmission unit 15 of the base station 10 transmits the acquired modulation and coding level to the mobile station 20 (S16).

Thereafter, in the downlink direction, the base station 10 and the mobile station 20 transmit and receive radio signal which is modulated and encoded using the acquired modulation and coding level.

As explained above, the implementation loss value includes propagation path estimation error value, rounding error value, and quantization error when calculating the SINR, and is the loss value when a circuit is implemented in the mobile station 20. The implementation loss value takes different value according to the manufacturing source, the period of manufacture, and similar, and so takes different value according to individual difference in mobile station 20. The modulation and coding level acquired by the modulation and coding level acquisition unit 141 takes into consideration the implementation loss value as well as the downlink communication quality (SINR). Hence the radio communication system 1 can perform modulation and coding using the optimal modulation method and similar, according to individual difference in mobile stations 20. In other words, the communication quality information is information due to external factor of the mobile station 20, and the implementation loss value is information due to internal factor of the mobile station 20. The base station 10 decides the modulation and coding level using not only external factor, but also internal factor. Hence the radio communication system 1 can improve transmission efficiency compared with cases in which the modulation and coding level is decided based only on the downlink communication quality information.

Further, the base station 10 does not request the modulation and coding level from the mobile station 20, and so an overhead problem does not arise.

Also, the mobile station 20 transmits the implementation loss value prior to the start of communication, and the base station 10 can acquire the downlink quality information according to the state of the propagation path, so that modulation and similar can be performed using the optimum modulation and coding level according to constantly-changing state of the propagation path.

Further, in the embodiment, although the implementation loss value is transmitted from the mobile station 20 to the base station 10, the base station 10 takes control in deciding the modulation and coding level.

Next, another embodiments is explained. In the above-described example, the mobile station 20 transmits the implementation loss value at the start of communication. For example, the mobile station 20 may transmit to the base station 10 the implementation loss value together with the downlink communication quality information. FIG. 5 is a sequence diagram illustrating this operation example.

The base station 10 transmits the known signal to the mobile station 20 (S20). The mobile station 20 measures the downlink communication quality based on the received known signal (S21), and acquires the implementation loss value from the implementation loss value storage unit 24

(S22). And, the mobile station 20 transmits information regarding to the estimated downlink communication quality and implementation loss value to the base station 10 (S23).

Based on the downlink communication quality information and implementation loss value, the base station 10 acquires (selects) the corresponding modulation and coding level from the modulation and coding level correspondence table 142 (S24). And, the base station 10 transmits the modulation and coding level to the mobile station 20. Thereafter, the modulation and similar are performed using the selected modulation and coding level.

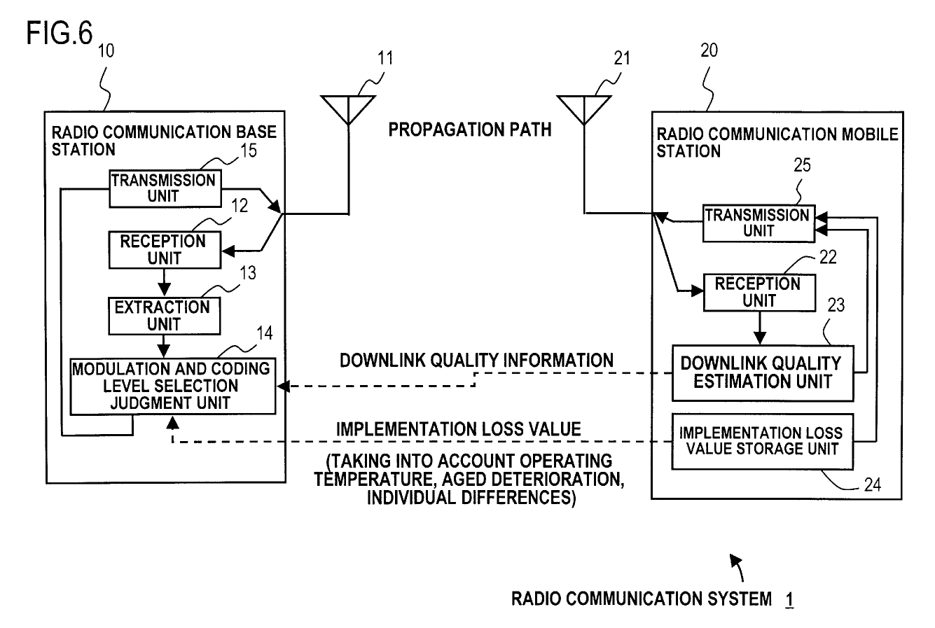

Further, the mobile station 20 may store, in the implementation loss value storage unit 24, a value obtained by adding a correction value to the implementation loss value. As explained above, there is individual difference among implementation loss values. Further, the implementation loss value for the mobile station 20 changes due to operating temperature and aged deterioration. Taking such circumstance into account, a value with the correction value added in advance may be stored as the implementation loss value. For example, when the implementation loss value is measured to be “A” dB in simulations or similar, a value “A+α” obtained by adding the correction value “α” dB, which takes into account the aged deterioration after two years, is stored as the implementation loss value in the storage unit 24. And, the mobile station 20 transmits to the base station 10 the implementation loss value with the correction value added (see FIG. 6). Thereafter operation is similar to that of the above-described embodiment.

Further, the above-described embodiment is explained assuming that the implementation loss value is stored in advance in the implementation loss value storage unit 24. For example, the mobile station 20 may include an implementation loss value measurement unit, and in the implementation loss value measurement unit the implementation loss value may be measured as appropriate, and the value stored in the storage unit 24.

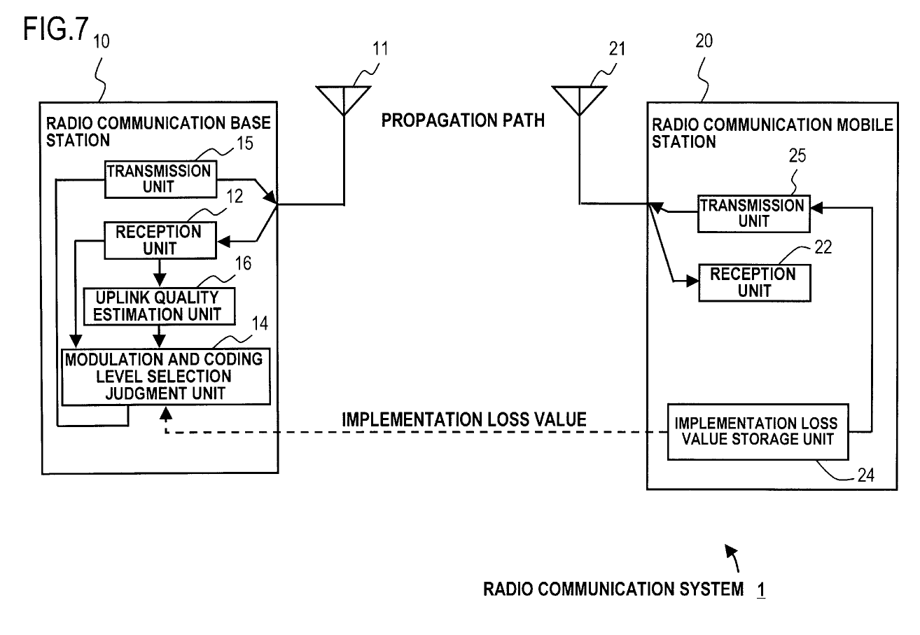

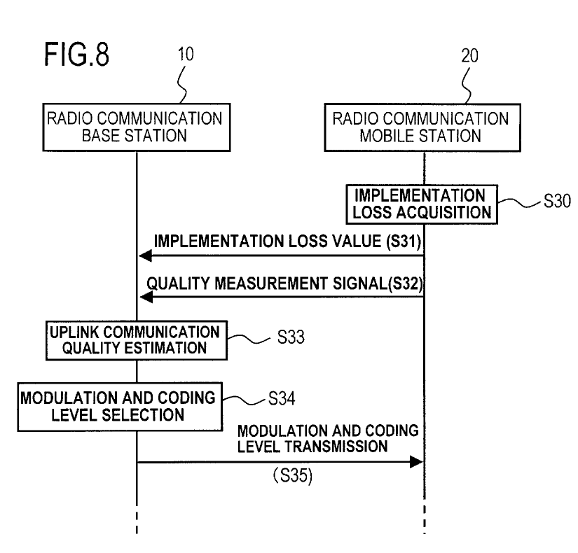

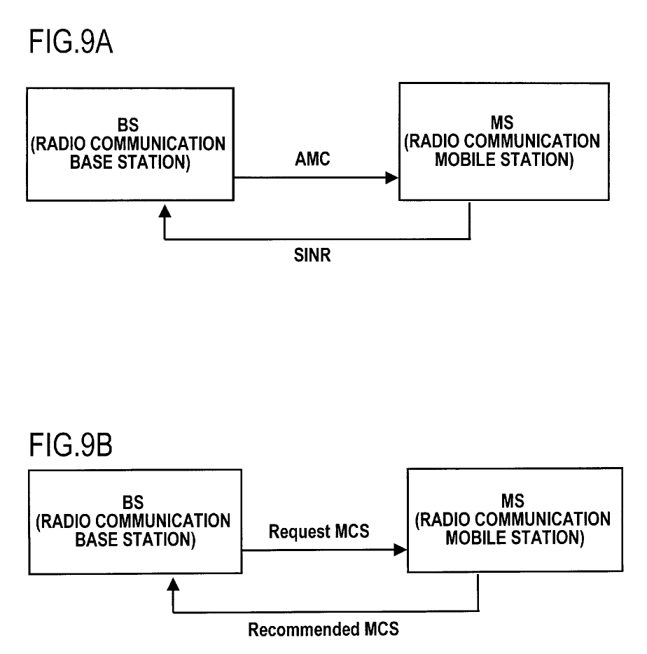

Further, the above-described embodiments are all examples using an adaptive modulation in the downlink direction from the base station 10 to the mobile station 20. Implementation in the uplink direction from the mobile station 20 to the base station 10 is also possible. FIG. 7 illustrates an example of the configuration of the radio communication system 1 in the uplink direction, and FIG. 8 is a sequence diagram illustrating an example of operation.

As illustrated in FIG. 7, the base station 10 further includes an unlink quality estimation unit 16. The reception unit 12 of the base station 10 receives quality measurement signal from the mobile station 20, and the uplink quality estimation unit 16 estimates uplink-direction communication quality based on the quality measurement signal from the reception unit 12. For example, the quality estimation unit 16 measures the SINR based on the quality measurement signal to estimate the uplink-direction communication quality.

As illustrated in FIG. 8, the transmission unit 25 of the mobile station 20 acquires the implementation loss value from the implementation loss value storage unit 24 (S30), and transmits the implementation loss value to the base station 10 at the start of communication (S31). Next, the transmission unit 25 of the mobile station 20 transmits the uplink quality measurement signal to the base station 10 (S32).

Next, the uplink quality estimation unit 16 of the base station 10 estimates the uplink communication quality (S33). The uplink quality estimation unit 16 may also measure quality using the transmission signal for the implementation loss value. In this case, the processing of S32 is eliminated.

Next, based on uplink quality information from the uplink quality estimation unit 16 and the implementation loss value from the reception unit 12, the modulation and coding level selection judgment unit 14 acquires (selects) the corresponding modulation and coding level from the modulation and coding level correspondence table 142 (S34). For the uplink direction also, the correspondence table 142 may be the same as in the above-described examples. Thereafter operation is similar to that of the above-described embodiments.

Further, the above-described embodiments are all examples in which the SINR is used as the quality information. Other than the SINR, the SIR (Signal to Interference power Ratio), SNR (Signal to Noise Ratio), CINR (Carrier to Interference plus Noise Ratio), CIR (Carrier to Interference power Ratio), or similar may be used.

Further, in all the above-described embodiments, the base station 10 may be a radio communication access point, and the mobile station 20 may be a radio communication terminal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has been described in detail, it should be understood that the various changes, substitutions, and alterations could be made hereto without departing from the spirit and scope of the invention.

What is claimed is:

1. A radio communication method in a radio communication system in which radio communication is performed between a radio communication base station apparatus and a radio communication mobile station apparatus, comprising:
transmitting, by the radio communication mobile station apparatus, an implementation loss value of the radio communication mobile station apparatus to the radio communication base station apparatus.

2. The radio communication method according to claim 1, further comprising: deciding, by the radio communication base station apparatus, a modulation and coding level based on the received implementation loss value.

3. The radio communication method according to claim 2, wherein the modulation and coding level is decided based on communication quality between the radio communication base station and radio communication mobile station apparatus, and the implementation loss value.

4. The radio communication method according to claim 3, further comprising:
measuring, by the radio communication mobile station apparatus, the communication quality of a downlink from the radio communication base station apparatus to the radio communication mobile station apparatus, and transmitting the measured communication quality to the radio communication base station apparatus, wherein
the modulation and coding level is decided based on the communication quality and the implementation loss value from the radio communication mobile station apparatus.

5. The radio communication method according to claim 3, further comprising:
measuring, by the radio communication base station apparatus, communication quality of an uplink from the radio communication mobile station apparatus to the radio communication base station apparatus, wherein
the modulation and coding level is decided based on the measured communication quality and the implementation loss value.

6. The radio communication method according to claim 3, wherein
the radio communication base station apparatus includes a modulation and coding level correspondence table, and
the modulation and coding level is decided by acquiring the modulation and coding level corresponding to the communication quality and the implementation loss value, from the modulation and coding level correspondence table

7. The radio communication method according to claim 2, wherein the communication quality is a signal to interference plus noise ratio.

8. The radio communication method according to claim 1, wherein the implementation loss value is a value adding to a correction value relating to an individual difference, operating temperature, or aged deterioration of the radio communication mobile station apparatus.

9. The radio communication method according to claim 1, wherein the radio communication mobile station apparatus transmits the implementation loss value at a stat time of communicating with the radio communication base station apparatus.

10. The radio communication method according to claim 1, further comprising:
reading, by the radio communication mobile station apparatus, the implementation loss value from an implementation loss value storage unit in which the implementation loss value is stored, wherein
the read implementation loss value is transmitted.

11. The radio communication method according to claim 2, wherein the modulation and coding level includes a modulation scheme to modulate signal, and a coding rate to encode the signal, in the radio communication base station and radio communication mobile station apparatus.

12. A radio communication base station apparatus for performing radio communication with a radio communication mobile station apparatus, comprising:
a reception unit which receives an implementation loss value of the radio communication mobile station apparatus transmitted from the radio communication mobile station apparatus.

13. A radio communication mobile station apparatus for performing radio communication with a radio communication base station apparatus, comprising:
a transmission unit which transmits an implementation loss value of the radio communication mobile station apparatus to the radio communication base station apparatus.

14. A radio communication system, comprising:
a radio communication base station apparatus; and
a radio communication mobile station apparatus; wherein
radio communication is performed between the radio communication base station and radio communication mobile station apparatus,
the radio communication mobile station apparatus includes a transmission unit which transmits an implementation loss value of the radio communication mobile station apparatus, and
the radio communication base station apparatus includes a reception unit which receives the implementation loss value transmitted from the radio communication mobile station apparatus.
